(19) United States
(12) Patent Application Publication
(10) Pub. No.: US 2014/0184371 A1
(43) Pub. Date: Jul. 3, 2014

(54) INSULATING MATERIAL CONTAINING POLY(PHENYLENE-1,3,4-OXADIAZOLE)

(71) Applicant: E I DU PONT DE NEMOURS AND COMPANY, Wilmington, DE (US)

(72) Inventors: Mark Andrew Harmer, Landenberg, PA (US); Sharlene Renee Williams, Wilmington, DE (US); Michael W. Cobb, Wilmington, DE (US)

(73) Assignee: E I DU PONT DE NEMOURS AND COMPANY, Wilmington, DE (US)

(21) Appl. No.: 13/729,124

(22) Filed: Dec. 28, 2012

(51) Int. Cl. H01B 3/30; H01F 27/12

(52) U.S. Cl. CPC H01B 3/303; H01F 27/12
USPC 336/58; 162/157.2; 428/116

(57) ABSTRACT

A nonwoven web of poly(phenylene-1,3,4-oxadiazole) and polymetaphenylene isopthalamide. was found to have greater retention of tensile strength than kraft paper after immersion in oil at high temperature, making it useful as an insulation material for transformers.

### FIELD OF THE INVENTION

The present invention relates to nonwoven papers useful for electrical insulation. The nonwoven papers contain poly(phenylene-1,3,4-oxadiazole) or a composite of poly(phenylene-1,3,4-oxadiazole) and polymetaphenylene isopthalamide.

### BACKGROUND

Electrical transformers typically have windings of conducting wire which must be separated by a dielectric (i.e. non-conducting) material. Usually the coils and dielectric material are immersed in a fluid dielectric heat transfer medium to insulate the conductor and to dissipate heat generated during operation. The heat-transfer medium, which is typically an oil such as mineral oil or a sufficiently robust vegetable oil, also acts as a dielectric. The most abundantly used dielectric material has been kraft paper or board, which is made from wood pulp prepared using the kraft chemical process.

Papers made from high performance materials have been developed to provide papers with improved strength and/or thermal stability. Aramid paper, for example, is synthetic paper composed of aromatic polyamides. Because of its heat and flame resistance, electrical insulating properties, toughness and flexibility, the paper has been used as electrical insulation material and a base for aircraft honeycombs. Of these materials, Nomex® of DuPont (U.S.A.) is manufactured by mixing poly(metaphenylene isophthalamide) floc and fibrids in water and then subjecting the mixed slurry to papermaking process to make formed paper followed by hot calendering of the formed paper. This paper is known to have excellent electrical insulation properties, strength and toughness, which remains high even at high temperatures. However this paper is costly.

Other high performance polymers have been used in various compositions for insulating materials. Polyoxadiazole, a polymer of oxadiazole rings and aromatic rings, has been used as a component in different insulating materials. JP 48069882 A discloses a gel film of polyoxadiazole in a laminate with insulation paper. U.S. Pat. No. 8,118,975 discloses a highly printable, thermally stable paper made of fibrids of a polymer or copolymer derived from a diaminodiphenyl sulfone (4,4′- and/or 3,3′) combined with a high performance floc that may be para-aramid, meta-aramid, carbon, glass, liquid crystalline polyester, polyphenylene sulfide, polyether-ketone-ketone, polyether-ether-ketone, polyoxadiazole, and/or polybenzazole. Disclosed in FR2376501 is insulating paper composed of short synthetic fibers of poly-m-phenylene isophthalamide, polydiphenylene 4,4′-sulphone-terephthalamide, polyoxadiazole or polyethylene terephthalate, and fibrids of aromatic polyesters and other binders such as cotton cellulose.

A need remains for alternative insulating papers having physical characteristics suitable for long term use in electrical transformers. Similarly, a need exists for an electrical apparatus comprising such insulating material.

### SUMMARY

In one aspect, the present invention provides an insulating material comprising a nonwoven web, the web comprising a (co)polymer of phenylene-1,3,4-oxadiazole, wherein the insulating material does not include: (1) polymer or copolymer derived from a diaminodiphenyl sulfone; or, (2) aromatic polyesters and copolyesters obtained from aromatic bisphenols and aromatic dicarboxylic acids.

In another aspect the insulating material further comprises polymetaphenylene isophthalamide.

The non woven paper can be part of a device comprising an electrical conductor and an electrically insulating material such as, for example, a transformer. The conductor and the insulating material of said device can each comprise a (co)polymer of phenylene-1,3,4-oxadiazole and lacking any polymer or copolymer derived from a diaminodiphenyl sulfone, and also lacking any aromatic polyesters and copolyesters made from aromatic bisphenols and aromatic dicarboxylic acids, and optionally comprising polymetaphenylene isophthalamide.

A further aspect of the invention provides a process for making a nonwoven insulating paper comprising:
a) providing a solid, slurry, or solution of a (co)polymer of phenylene-1,3,4-oxadiazole;
b) optionally pulping the (co)polymer of phenylene-1,3,4-oxadiazole prior to step (c);
c) blending the solid, slurry, or solution of step (a) with poly-metaphenylene isophthalamide fibrids to form a polymer mixture, and pulping the phenylene-1,3,4-oxadiazole if it was not pulped in step (b);
d) draining excess liquid from the polymer mixture to yield a wet paper composition; and
e) drying and pressing the wet paper composition to make a formed paper.

The present nonwoven paper is useful as an insulating (dielectric) material in electrical transformers. When immersed in oil, a typical fluid dielectric heat transfer medium, the paper retains tensile strength and therefore is an improved insulation paper.

### DETAILED DESCRIPTION OF THE INVENTION

This invention is related to the development of a new nonwoven insulating material for use in electrical applications such as in transformers. The insulating material contains poly(phenylene-1,3,4-oxadiazole) or a composite of poly(phenylene-1,3,4-oxadiazole) and polymetaphenylene isopthalamide.

The methods, compositions, and articles described herein are described with reference to the following terms.

As used herein, where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “slurry” refers to a mixture of insoluble material and a liquid.

As used herein, the term “wt %” means weight percent.

As used herein, the term “kraft paper” means a paper made by a kraft pulping process wherein the paper consists of a web of pulp fibers (normally from wood or other vegetable fibers). Kraft paper is typically formed from an aqueous slurry on a wire or screen but other processes can be conventional. Kraft paper is held together by hydrogen bonding. Kraft paper may also contain a variety of additives and fillers. See, for example, Handbook of Pulping and Papermaking, Christopher J. Bierman, Academic Press, 1996.

As used herein, the term “nonwoven web” means a manufactured web, paper, or sheet of randomly orientated fibers or filaments positioned to form a planar material without an identifiable pattern. Examples of nonwoven webs include meltblown webs, spunbond webs, carded webs, air-laid webs, wet-laid webs, and spunlaced webs and composite webs comprising more than one nonwoven layer. Nonwoven webs for the processes and articles disclosed herein are desirably prepared using a “direct laydown” process. “Direct laydown” means spinning and collecting individual fibers or plexifilaments directly into a web or sheet without winding filaments on a package or collecting a tow.

The term “fibrids”, as used herein, means a very finely-divided polymer product of fibrous or film-like particles with at least one of their three dimensions being of minor magnitude relative to the largest dimension. Filmy fibrids are essentially two-dimensional particles having a length and width on the order of 10 to 1000 micrometers and a thickness of 0.1 to 1 micrometer. Fibrous shape or stringy fibrids usually have length of up to 2-3 mm, a width of 1 to 50 microns, and a thickness of 0.1 to 1 micrometer, Fibrids are made by streaming a polymer solution into a coagulating bath of liquid that is immiscible with the solvent of the solution. The stream of polymer solution is subjected to strenuous shearing forces and turbulence as the polymer is coagulated.

The term “floc”, also called “flocs” and “flocks”, as used herein, means fibers having a length of 2 to 25 millimeters, preferably 3 to 7 millimeters and a diameter of 3 to 20 micrometers, preferably 5 to 14 micrometers. Floc is typically made by cutting continuous spun filaments into specific-length pieces using well-known methods in the art.

The term “aramid”, as used herein, means a polyamide wherein at least 85% of the amide (—CONH—) linkages are attached directly to two aromatic rings. A meta-aramid is such a polyamide that contains a meta configuration or meta-oriented linkages in the polymer chain.

The term “oil” as used herein refers to any dielectric fluid that includes mineral oil, synthetic hydrocarbons, silicones, ester-containing oil which includes synthetic mono, di or polyol estersl as well as natural ester-containing oil, which is typically an oil obtained from plant material (typically seed) called vegetable oil or mixtures thereof. These dielectric fluids may also contain additives that include antioxidants, pour point depressants, metal passivators, and corrosion inhibitors.

As used herein the term “to pulp” or “pulping” used as a verb means to process fibers into thinner, smaller and/or shorter pieces. Typically pulping is achieved by application of mechanical means such as shearing (which may be accompanied by coagulating), blending, cutting, and/or similar process. The resulting pulped fibers may be in the form of floc, fibrids, fibrils, sheared fibers, or any combination of these forms.

The present insulating material is a nonwoven web, also considered to be a paper or board, which comprises a polymer or a copolymer of phenylene-1,3,4-oxadiazole, or mixtures thereof. Suitable polymers of phenylene-1,3,4-oxadiazole may be selected from poly(para-phenylene-1,3,4-oxadiazole) polymers or poly(meta-phenylene-1,3,4-oxadiazole) polymers. Suitable co-polymers of phenylene-1,3,4-oxadiazole comprise para-phenylene-1,3,4-oxadiazole and meta-phenylene-1,3,4-oxadiazole. The relative amounts of para- and meta-forms of phenylene-1,3,4-oxadiazole may be in any ratio of amounts between about 99:1 and 1:99. For convenience, polymers and copolymers of phenylene-1,3,4-oxadiazole, and combinations thereof, may be generically referred to herein as simply “(co)polymers” of phenylene-1,3,4-oxadiazole, unless the context requires reference to a specific polymer of phenylene-1,3,4-oxadiazole or a specific copolymer phenylene-1,3,4-oxadiazole.

The (co)polymer of phenylene-1,3,4-oxadiazole may be prepared by any method, such as described in Examples 1 and 2 herein which uses hydrazine, terephthalic acid, and oleum to prepare the polymer, and hydrazine, terephthalic acid, isophthalic acid and oleum to prepare the copolymer. One skilled in the art is readily able to synthesize these polymers. Typically the fibers in a preparation of the (co)polymer are reduced in size (thinner and/or shorter) by application of mechanical means such as shearing (which may be accompanied by coagulating), blending, cutting, or similar process. The resulting fibers of the (co)polymer of phenylene-1,3,4-oxadiazole may be in the form of floc, fibrids, fibrils, sheared fibers, or any combination of these forms.

In one embodiment the present insulating material additionally contains polymetaphenylene isophthalamide, an aromatic meta-polyamide, Meta-aramid fibers can be spun by dry or wet spinning using any number of processes. U.S. Pat. No. 3,063,966, U.S. Pat. No. 3,227,793, U.S. Pat. No. 3,287,324, U.S. Pat. No. 3,414,645, and U.S. Pat. No. 5,667,743 are illustrative of useful methods for making aramid fibers that could be used. Meta-aramid poly-metaphenylene isophthalamide fibers are commercially available, such as Nomex® aramid fiber available from E. I. du Pont de Nemours and Company (Wilmington, Del.), Teijinconex® aramid fiber available from Teijin Ltd. of (Tokyo, Japan), and Aramet® from Aramid, Ltd, (Hilton Head Island, S.C.).

The relative amounts of (co)polymer of phenylene-1,3,4-oxadiazole and of polymetaphenylene isophthalamide in the present material may vary. The ratio of weight percent of (co)polymer of phenylene-1,3,4-oxadiazole to weight percent of the meta-aramid may be between about 5:95 and 95:5. Typically the material contains at least about 30 weight % of meta-aramid.

The polymetaphenylene isophthalamide is in the form of fibrids, and optionally additionally of floc. Preferably, fibrids have a melting point or decomposition point above 320° C. Fibrids are not fibers, but they are fibrous in that they have fiber-like regions connected by webs. Fibrids typically have an aspect ratio of 5:1 to 10:1. Fibrids may be used wet in a never-dried state and can be deposited as a binder physically entwined about other ingredients or components of a paper. The fibrids can be prepared by any method including using a fibrillating apparatus of the type disclosed in U.S. Pat. No. 3,018,091 where a polymer solution is precipitated and sheared in a single step. Fibrids can also be made via the processes disclosed in U.S. Pat. No. 2,988,782, U.S. Pat. No. 2,999,788, and U.S. Pat. No. 3,756,908.

The polymetaphenylene isophthalamide floc may be fibers of any length useful for preparation of a nonwoven web. Typically the floc fibers have length of 2 to 25 millimeters, preferably 3 to 7 millimeters and a diameter of 3 to 20 micrometers, preferably 5 to 14 micrometers. Floc is typically made by cutting continuous spun filaments into specific-length pieces using well-known methods in the art. Examples of floc preparation are described in U.S. Pat. No. 3,063,966, U.S. Pat. No. 3,133,138, U.S. Pat. Nos. 3,767,756, and 3,869,430.

In one embodiment, polymetaphenylene isophthalamide fibrids are 100% of the polymetaphenylene isophthalamide in the present insulating material. In another embodiment polymetaphenylene isophthalamide floc is also present. In the present invention, the polymetaphenylene isophthalamide consists essentially of either fibrid material or a mixture of fibrid and floc material, so that the amount of floc material that is included can be determined by mass balance. For example, in one embodiment, the polymetaphenylene isophthalamide can be present in an amount of up to 75 weight percent floc, with the remainder (25 to 100 weight percent) being fibrid. In other embodiments, the polymetaphenylene isophthalamide comprises no more than 50 wt % of floc.

One of skill in the art can readily determine the optimal ratio of (co)polymer of phenylene-1,3,4-oxadiazole to polymetaphenylene isophthalamide, and of polymetaphenylene isophthalamide fibrids to floc, to be used in the particular manufacturing process to obtain the desired properties of the present insulating material, typically with consideration of economic factors.

In addition, in other embodiments conventional additives may be included in the present insulating material. Examples of suitable additives include a polymeric binder such as polyvinyl alcohol, polyvinyl acetate, polyamide resin, epoxy resin, phenolic resin, polyurea, polyurethane, melamine formaldehyde, and polyester.

Additional ingredients such as fillers for the adjustment of paper conductivity and other properties, pigments, antioxidants, etc in powder or fibrous form can be added to the insulating material composition of this invention. An additional ingredient may be a clay such as Kaolin clay, which is commercially available from Imerys (Roswell, Ga.). When including a clay, a flocculant such as Praestol™ is typically included. Flocculants are commercially available such as Praestol™ K144L from Ashland Inc. (Greensboro, N.C.).

If desired, an inhibitor can be added to provide resistance to oxidative degradation at elevated temperatures. Preferred inhibitors are oxides, hydroxides and nitrates of bismuth. An especially effective inhibitor is a hydroxide and nitrate of bismuth. One desired method of incorporating such fillers is by first incorporating the fillers into the fibrids during fibrid formation. Other methods of incorporating additional ingredients include adding such components to the slurry during paper forming, spraying the surface of the formed paper with the ingredients and other conventional techniques.

The (co)polymer of phenylene-1,3,4-oxadiazole and optional polymetaphenylene isophthalamide are used to form an insulating material that is a dielectric paper with high thermal stability that is a nonwoven web. As employed herein the term paper is employed in its normal meaning and it can be prepared using conventional paper-making processes and equipment. The paper can be formed on equipment of any scale from laboratory filters, screens, or handsheet mold containing a forming screen, to commercial-sized papermaking machinery, such as a Fourdrinier or inclined wire machines. Reference may be made to U.S. Pat. No. 3,756,908 and U.S. Pat. No. 5,026,456 for processes of forming fibers into papers.

The general process involves making an aqueous dispersion of (co)polymer of phenylene-1,3,4-oxadiazole fibers, typically in the form of the form of fibrids and/or floc, and optionally further containing polymetaphenylene isophthalamide, with any optional additional ingredients, blending the dispersion to make a slurry, depositing the slurry on a support, draining the excess liquid from the slurry to yield a wet composition and drying the wet composition to form a paper. Dispersion of the (co)polymer of phenylene-1,3,4-oxadiazole and polymetaphenylene isophthalamide, when included, in aqueous liquid may be made in any order, concurrently, or in separate batches that are mixed. The (co)polymer of phenylene-1,3,4-oxadiazole may be pulped prior to or after addition of other components.

The aqueous liquid of the dispersion is generally water, but may include various other materials such as pH-adjusting materials, forming aids, surfactants, defoamers and the like. The aqueous liquid is usually drained from the dispersion by conducting the dispersion onto a screen, wire belt, or other perforated support, retaining the dispersed solids and then passing the liquid to yield a wet paper composition. The wet composition, once formed on the support, is usually further dewatered by vacuum or other pressure forces, optionally washed, and further dried by evaporating the remaining liquid.

A next step, which can be performed if higher density and strength are desired, is calendaring one or more layers of the paper between two heated calendering rolls with the high temperature and pressure from the rolls increasing the bond strength of the paper. Alternatively, one or more layers of the paper can be compressed in a platen press at a pressure, temperature and time, which are optimal for a particular composition and final application. Also, heat-treatment as an independent step before, after or instead of calendering or compressing, can be conducted if strengthening or some other property modification is desired without or in addition to densification. Calendering also provides the paper with a smooth surface for printing.

The present insulating material has improved retention of tensile strength. Retention of tensile strength may be assessed using an accelerated aging assay where the insulating material is immersed in oil at elevated temperature, as described herein. Oil used in the assay may be any dielectric fluid including mineral oil, synthetic hydrocarbons, silicones, ester-containing oils such as a synthetic mono, di or polyp ester or natural ester-containing oils, the latter of which is typically a vegetable oil. The preferred vegetable oils include high oleic soybean, high oleic sunflower, high oleic canola or olive oil. The oil may include additives, such as anti-oxidants, typically added to increase stability. The elevated temperature of the assay is typically at least about 110° C., and may be at least about 120° C., 130° C., 140° C., 150° C., 160° C., 170° C., 180° C., 190° C., 200° C., or higher.

Retention of tensile strength, represented by the measurement of tenacity at maximum, by the present insulating material exceeds that of kraft paper after treating with any combination of these conditions. In one embodiment, the tensile strength retention at rupture, after at least one week of immersion in oil at a temperature that is at least about 180° C., exceeds that of upgraded kraft paper after the same treatment. For example, at least about 80% of the original tensile strength is retained when the present insulation material contains at least about 30 weight percent of polymetaphenylene isophthalamide in combination with poly(para-phenylene-1,3,4-oxadiazole. In an embodiment as shown in Example 15 herein, the tensile strength retention at rupture of this paper, after four weeks of immersion in vegetable oil at about 180° C., is at least about four-fold higher than that of upgraded kraft paper after the same treatment. In one embodiment the tensile strength of this paper is at least about 30 MPa after two weeks of immersion in vegetable oil at about 180° C.

The present insulating material may be a part of a multilayer structure. Other layers in the structure may be any type of insulating material in a paper-type form. Several plies with the same or different compositions can be combined together into the final multilayer structure during forming and/or calendering. For example, a multilayer structure containing layers of insulating papers is disclosed in US 2011/0316660. The present insulating material may be added as a layer in the described structure, or may be used in a structure containing one or more other types of insulating papers. The present insulating material may be an outer and/or an internal layer in a structure of two or more layers. It is preferred that other insulating papers used in the multilayer structure have retention of tensile strength that at least matches the tensile strength retention of the present insulating material used in the structure, in which case kraft paper would not be included.

In one embodiment, the formed paper has a density of about 0.1 to 0.5 grams per cubic centimeter. In some embodiments the thickness of the formed paper ranges from about 0.002 to 0.015 inches. The thickness of the calendered paper is dependent upon the end use or desired properties and in some embodiments is typically from 0.001 to 0.005 mils (25 to 130 micrometers) thick. In some embodiments, the basis weight of the paper is from 0.5 to 6 ounces per square yard (15 to 200 grams per square meter).

The present paper comprising a nonwoven web as described herein is useful as a component in materials such as printed wiring boards; or where dielectric properties are useful, such as electrical insulating material for use as a wrapping for wires and conductors, and in motors, transformers and other power equipment. The wire or conductor can be totally wrapped, such a spiral overlapping wrapping of the wire or conductor, or can wrap only a part or one or more sides of the conductor as in the case of square conductors. The amount of wrapping is dictated by the application and if desired multiple layers of the paper can be used in the wrapping. In another embodiment, the paper can also be used as a component in structural materials such as core structures or honeycombs. For example, one or more layers of the paper may be used as the primarily material for forming the cells of a honeycomb structure. Alternatively, one or more layers of the paper may be used in the sheets for covering or facing the honeycomb cells or other core materials.

The paper disclosed herein is suitable for use in applications requiring electrical insulating material having the properties of the papers disclosed herein, such as liquid-filled power transformers, distribution transformers, traction transformers, reactors, and their accessory equipment such as switches and tap changers, all of which are fluid-filled. The combination of dielectric fluid and solid insulating paper as described herein provides electrical insulation for an electrical apparatus. In one embodiment, the electrical apparatus comprising the insulating material disclosed herein is an electrical transformer, an electrical capacitor, a fluid-filled transmission line, an electrical power cable, an electrical inductor, or a high voltage switch. In one embodiment, the electrical apparatus is a closed transformer. In one embodiment, the electrical apparatus is an open transformer having a headspace containing an inert gas. In one embodiment, a dielectric material comprises a paper as described herein impregnated with at least 10 weight percent of a dielectric fluid. In one embodiment the transformer is a large scale transformer having the capacity to handle at least 200 kVA, and more generally at least 400 kVA.

The present paper can be used in transformers with dielectric fluids comprising a triglyceride oil, such as vegetable oils, vegetable oil based fluids, and algal oils. Dielectric fluids such as mineral oil, synthetic esters, silicone fluids, and poly alpha olefins may also be used. Examples of vegetable oils include but are not limited to sunflower oil, canola oil, rapeseed oil, corn oil, olive oil, coconut oil, palm oil, high oleic soybean oil, commodity soybean oil, castor oil, and mixtures thereof. Examples of vegetable oil based fluids that can be used are Envirotemp® FR3™ fluid (Cooper Industries, Inc.) and BIOTEMP® Biodegradable Dielectric Insulating Fluid (ABB). Examples of algal oils include but are not limited to those disclosed in published patent application US 2010/0303957. An example of high fire point hydrocarbon oil that can be used is R-Temp® hydrocarbon oil (Cooper Industries, Inc.), Examples of synthetic esters include polyol esters which contain fatty acid moieties of less than about 10 carbon atoms in chain length. Commercially available synthetic esters that can be used include those sold under the trade names Midel® 7131 (The Micanite and Insulators Co., Manchester UK), REOLEC® 138 fluid (FMC, Manchester, UK), and ENVIROTEMP 200 fire-resistant fluid (Cooper Power Fluid Systems). In one embodiment, the dielectric fluid comprises a triglyceride oil. In one embodiment, the triglyceride oil comprises a vegetable oil, a vegetable oil based fluid, an algal oil, or mixtures thereof. In one embodiment, the vegetable oil comprises high oleic soybean oil. Typically, the dielectric fluid has a water content of about 500 ppm or less.

When used as insulating material for a liquid filled transformer, the papers disclosed herein can provide longer term benefit to both the manufacturer and the consumer, since the papers can maintain tensile strength, and in turn provide extended lifetime for a transformer. Traditional Kraft paper has lower strength retention and during the operation of a transformer (which is under both thermal and mechanical stress) can fall appart. This new types of composite give a longer operating lifetime.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows:

“hr” means hour(s), “min” means minute(s), “sec” means second(s), “d” means day(s), “L” means liter(s), “mL” means milliliter(s), “g” means grams, “g/L” means grams per liter, “mM” means millimolar, “μM” means micromolar, “nm” means nanometer(s), “mm” means millimeters, means centimeters, “wt %” means weight percent, “MPA” means megapascal(s), “psi” means pounds per square inch, “wt %” means weight percent, “DS” means degree of substitution; “RPM” means revolutions per minute, “psi” means pounds per square inch

### General Methods

Unless otherwise stated, the examples were all prepared using the following procedures. Ratios of reagents are given as mole ratios. 22% Oleum was obtained from Alfa Aesar® (Ward Hill, Mass.) and 18.7% oleum was obtained from Sigma-Aldrich® (St. Louis, Mo.). Terephthalic acid (TA) and isophthalic acid (IA) were obtained from Sigma-Aldrich®. Sulfuric add and sodium bicarbonate were obtained from EMD Chemicals Inc. (Gibbstown, N.J.). The Nomex® fibrid solution was prepared as described in U.S. Pat. No. 3,756,908. The Kaolin clay solution was Kaolin XP10-3000 (Imerys; Roswell, Ga.) and Praestol K144L was from Ashland Inc. (Greensboro, N.C.). The soybean oil was prepared from Plenish™ high oleic soybeans (Dupont-Pioneer; Johnston, Iowa).

### Accelerated Aging Procedure

### Steel Tube Method

Soybean oil was poured into a 5 L round-bottom flask until the flask was filled to ¾ of its volume. The flask was placed under vacuum and heated to 110° C. using an oil bath for one hour to dry the oil. The heat was removed and the oil was allowed to cool to room temperature before proceeding. Meanwhile, the hand sheets for testing were cut into 4.5 inch (11.43 cm) by 0.5 inch (1.27 cm) strips. These strips were then carefully placed into a 500 mL reaction kettle which was then covered, sealed and placed into an oil bath. A 1 L addition funnel was attached to the top of the kettle and 500 mL of the dried oil was poured inside. The addition funnel and kettle were placed under vacuum and the oil bath was heated to 115° C. overnight. The paper was soaked in the oil under nitrogen overnight at 115° C. The kettle was cooled to room temperature before opening the addition funnel under nitrogen. Control strips were removed and set aside for tensile testing. Into each of the 4 large steel pressurized tubes was placed three strips of the oil soaked paper along with one 6.0 inch (15.24 cm) by 1.0 inch (2.54 cm) strip of copper and one 6.0 inch (15.24 cm) by 1.0 inch (2.54 cm) strip of steel (to mimic a transformer). 200 mL of dried oil was aliquoted into four 250 mL plastic bottles. The uncapped plastic bottles and steel tubes were placed into a glove bagand purged with nitrogen for 30 minutes before filling each tube with one of the aliquots of oil and capping the tubes. The tubes were removed from the glove bag and placed into a 180° C. oven for the specified amount of time (3, 7, 14, or 28 days). The tubes were removed from the oven and cooled to room temperature, and the paper samples were removed and tested for tensile properties. Properties were tested using an Instron machine with BlueHill software, grips 1.0″ by 0.5″ (2.54×1.27 cm) using 60 psi (413.69 kilopascal) of pressure. The area tested was 0.5 inch (1.27 cm) wide by 2.0 inch (5.08 cm) in length, pulling the sample at 2.0 inches per minute (5.08 cm/min) until failure.

### Glass Tube Method

Each hand sheet was cut into five 1 inch (2.54 cm) wide strips of varying length using a razor blade. The strips were placed into appropriate sized glass pressure tubes (Ace Glass), 5 strips per tube. These tubes were placed into a vacuum oven set for 150° C. overnight under vacuum to dry. The tubes were cooled to room temperature before pouring soybean oil into each tube to fully cover the paper strips. The tubes and the screw caps for the tubes were placed separately into a 150° C. oven under vacuum for twenty four hours. The heat and the vacuum were then replaced by a nitrogen purge for 12 hours. To one set of the tubes was added 200 ppm of water in order to simulate transformer conditions. The caps were screwed onto the tubes tightly before the tubes were placed securely on a shaker table set to 125 rpm for two hours. The tubes were then placed into a 200° C. oven and removed after the appropriate time (0-56 days, as needed). Paper strips were removed from the oil, blotted dry, and tested for tensile strength.

Tensile Strength and Elongation were determined for prepared papers on an Instron-type testing machine in accordance with ASTM D 828-93.

### Example 1

### Preparation of poly(para-phenylene-1,3,4-oxadiazole)-co-poly(meta-phenylene-1,3,4-oxadiazole using 80 molar % terephthalic acid and 20 molar % isophthalic acid

To a dried 3-neck reaction flask equipped with a stainless steel mechanical stirrer, nitrogen inlet, and reagent addition ports were added 26.154 g (0.201 moles) of solid hydrazine sulfate, 26.581 g (0.160 moles) of solid terephthalic acid, and 6.645 g (0.040 moles) of solid isophthalic acid via a funnel. The solid ingredients were mixed and blended together thoroughly for 15 minutes under nitrogen. To this blended mixture of solids was added 379.54 g of 18.7% oleum at room temperature while stirring. The reaction kettle was completely sealed and leak-free (including stirrer shaft) to prevent vapor phase ingredients from escaping the kettle. The mixture was mechanically stirred (250 RPM) at room temperature for 10 minutes. The light tan mixture containing solid chunks was immersed into an oil bath and the bath was set to heat to 135° C. After 26 minutes, the oil bath had reached 135° C., the clear tan mixture had not become viscous and the timing for the 4 hour polymerization was begun. After 20 minutes, the mixture contained bubbles and after 60 minutes it was viscous and full of bubbles. After 240 minutes in the 135° C. bath, the very viscous mixture was removed from the heated bath and the excess SO₃ was quenched by the drop-wise addition of 145.42 g of 96.4% sulfuric acid (5.235 g water) over 20 minutes. The viscous mixture was further diluted by the addition of another 192.15 g of 96.4% sulfuric acid. The viscous mixture was stirred slowly overnight. The produced poly(para-phenylene-1,3,4-oxadiazole)-co-poly(meta-phenylene-1,3,4-oxadiazole is a 3.71 wt % polymer solution in sulfuric acid and is referred to as POD1.

### Example 2

### Preparation of poly(para-phenylene-1,3,4-oxadiazole)

To a dried 3-neck reaction flask equipped with a stainless steel mechanical stirrer, nitrogen inlet, and reagent addition ports were added 26.154 g (0.201 moles) of solid hydrazine sulfate and 33.226 g (0.200 moles) of solid terephthalic acid via a funnel. The solid ingredients were mixed and blended together, then 488.00 g of 22% oleum was added at room temperature while stirring. The reaction kettle was completely sealed and leak-free (including stirrer shaft) to prevent vapor phase ingredients from escaping the kettle. The mixture was mechanically stirred (180 RPM) at room temperature for 10 minutes. The light tan mixture containing solid chunks was immersed into an oil bath and the bath was set to heat to 135° C. After 30 minutes, the oil bath had reached 135° C., the clear amber mixture had not become viscous and the timing for the 4 hour polymerization was begun. After 30 minutes, the mixture contained bubbles and had a noticeable increase in viscosity. After 240 minutes in the 135° C. bath, the very viscous mixture was removed from the heated bath and allowed to cool down for 15 minutes. Then 350.1 g of 96.4% sulfuric acid was added slowly to the mixture. The produced poly(para-phenylene-1,34-oxadiazole) is a 3.3 wt % polymer solution in sulfuric acid and is referred to as POD2.

### Example 3

### Preparation of paper from poly(para-phenylene-1,3,4-oxadiazole)-co-poly(meta-phenylene-1,3,4-oxadiazole and Nomex® fibrils: Method 1

To a Waring blender containing an ice/water mixture was very slowly added 25.02 g of POD1 solution prepared in Example 1 (3.71 wt % polymer in sulfuric acid) as a thin stream while blending at a speed that formed a uniform vortex. The polymer formed a coil of fibers. After addition of the POD1, the speed was increased to full to pulp the fiber into smaller and shorter pieces. Next, 211.5 g of Nomex® fibrid solution (0.43 wt % polymer in water) was added and the mixture was blended at full speed. The resulting white slurry was poured onto a paper filter in a glass frit. The mixture was filtered, washed with DI water, with 2 wt % sodium bicarbonate solution and then two more times with DI water. The ratio of POD1:Nomex® in the prepared paper was 50:50,

### Example 4

### Preparation of paper from poly(para-phenylene-1,3,4-oxadiazole)-co-poly(meta-phenylene-1,3,4-oxadiazole and Nomex® fibrils: Method 2

To a Waring blender containing 201.36 g of Nomex® fibrid solution (0.43 wt % polymer) was very slowly added 26.34 g of POD1 solution prepared in Example 1 (3.71 wt % polymer in sulfuric acid) as a thin stream while blending at a speed that formed a uniform vortex. After the addition of the polymer mixture, the speed was increased to full to pulp and blend the mixture. The resulting white slurry was poured onto a paper filter in a glass frit. The mixture was filtered, washed with DI water, with 2 wt % sodium bicarbonate solution and then two more times with DI water. The ratio of POD1:Nomex® in the prepared paper was 50:50.

### Example 5

### Preparation of paper from poly(para-phenylene-1,3,4-oxadiazole)-co-poly(meta-phenylene-1,3,4-oxadiazole

To a Waring blender containing an ice/water mixture was very slowly added 53 g of POD1 solution prepared in Example 1 (3.71 wt % polymer in sulfuric acid) as a thin stream while blending at a speed that formed a uniform high vortex (higher speed than in Example 3). The resulting fiber material resembled a cotton ball containing fibers that are thinner and shorter than those prepared in Example 3. It was removed from the blender blade and washed with DI water. The fiber ball was then placed on top of a ˜50/50 ice/water mixture in the blender and placed on full speed to pulp for several minutes. The resulting white slurry was quickly poured onto a paper filter in a glass frit. The mixture was filtered, washed with DI water, with 2 wt % sodium bicarbonate solution and then two more times with DI water.

### Example 6

### Preparation of paper from poly(para-phenylene-1,3,4-oxadiazole)-co-poly(meta-phenylene-1,3,4-oxadiazole and Nomex® fibrids: Method 3

The following process was repeated four times as reactions A, B, C, and D. To a Waring blender containing a crushed ice/water mixture of ˜500 mL was very slowly added about 24 g of POD1 solution (see Table 1 for actual weights) prepared in Example 1 (3.71 wt % polymer in sulfuric acid) as a thin stream while blending at a speed that formed a fast but uniform vortex. The addition of the POD1 solution was accomplished by pouring slowly from a 25 mL scintillation vial fixed at ˜30 cm above the surface of the ice and water mixture in the blender over a 5-7 minute period. The polymer formed a coil of fibers which was removed from the acidic water in the blender. The coil of fiber was cut into 8-10 clumps which were soaked for 5-10 minutes in 300 mL of 3 wt % sodium bicarbonate solution to neutralize the fibers. After rinsing the blender, a mixture of about 216 g (see Table 1 for actual weights) of Nomex® fibrid solution (0.43 wt % polymer) and crushed ice (˜500 mL) was added to the blender. The clumps of neutralized POD1 fibers were added to the surface of the mixture under a fast but uniform vortex, and the blender was then placed on maximum speed to pulp for 5 minutes. The resulting white slurry was poured onto a paper filter in a glass frit. The mixture was filtered and washed three times with ˜50 mL of DI water. The filtrate from the DI water wash had a pH of 7. The ratio of POD1:Nomex® in the prepared paper was 50:50.

TABLE 1
Weights of POD1 and Nomex ® fibrid used in making paper pulp.

| | POD1 | POD1 | Nomex ® | Nomex ® |
|---|---|---|---|---|
| Reaction# | solution (g) | fiber (g) | solution (g) | fibrid (g) |
| A | 24.4 | 0.905 | 216.2 | 0.930 |
| B | 24.4 | 0.905 | 216.8 | 0.932 |
| C | 24.2 | 0.898 | 216.7 | 0.932 |
| D | 24.2 | 0.898 | 216.2 | 0.930 |

### Example 7

### Preparation of paper from poly(para-phenylene-1,3,4-oxadiazole)-co-poly(meta-phenylene-1,3,4-oxadiazole and Nomex® fibrids: Method 4

The following process was repeated three times as reactions A, B, and C. To a Waring blender containing about 210 g (see Table 2 for actual weights) of Nomex® fibrid solution (0.43 wt % polymer) was very slowly added about 24 g (see Table 2 for weights) of POD1 solution prepared in Example 1 (3.71 wt % polymer in sulfuric acid) as a thin stream while blending at a speed that formed a fast but uniform vortex. The addition of the POD1 solution was accomplished by pouring slowly from a 25 mL scintillation vial fixed at ˜30 cm above the surface of the solution in the blender over a 5-5.5 minute period. After the addition of the polymer mixture, the speed was increased to full to pulp and blend the mixture for 3 minutes. The temperature of the slurry was 37° C. The white slurry was poured onto a paper filter in a glass frit. The mixture was filtered, washed with DI water 2 times and then with 125 mL of 3 wt % sodium bicarbonate solution and then 3 more times with DI water. The filtrate was still acidic at this point. The pulp was again washed with 125 mL of 3 wt % sodium bicarbonate solution, then 3 more times with DI water and the filtrate wash had a pH of 7. The ratio of POD1:Nomex® in the prepared paper was 50:50.

After the water had been filtered from the fiber mat, the mat was lifted off of the frit and sandwiched between two sheets of blotting paper (Xpedx Veri Good blotting paper) and placed between two steel plates. The paper was dried using a Carver press with heated platens. Temperature was set to 135° C., pressure was set to 10,000 psi, the paper was left to dry in these conditions for 15 minutes. After drying, the blotting paper was removed and replaced with two sheets of Kapton and placed between two long, thin brass sheets. The paper was then submitted to a calender heated to 285° C. with the rollers at a pressure of 30 psi with the speed dial set to 20 (slow speed, about 1 ft/min). The brass sheets and Kapton were removed from the paper which was then submitted either to an accelerated aging test or tensile testing.

TABLE 2
Weights of POD1 and Nomex ® fibrid used in making paper pulp

| | POD1 | POD1 | Nomex ® | Nomex ® |
|---|---|---|---|---|
| Reaction# | solution (g) | fiber (g) | solution (g) | fibrid (g) |
| A | 24.4 | 0.905 | 210.0 | 0.903 |
| B | 24.2 | 0.898 | 210.0 | 0.903 |
| C | 24.1 | 0.894 | 210.1 | 0.903 |

### Example 8

### Preparation of paper from poly(para-phenylene-1,3,4-oxadiazole)-co-poly(meta-phenylene-1,3,4-oxadiazole and Nomex® fibrids: Method 5

The following process was repealed three times as reactions A, B, and C. To a Waring blender containing 200 mL of ˜15 C water was very slowly added about 24 g (see Table 3 for actual weights) of POD1 solution prepared in Example 1 (3.71 wt % polymer in sulfuric acid) as a thin stream while blending at maximum speed. The addition of the POD1 solution was accomplished by pouring slowly from a 25 mL scintillation vial fixed at ˜30 cm above the surface of the liquid in the blender over a 4-4.5 minute period. After the addition of the polymer mixture the blender was continued at maximum speed an additional 2 minutes. The temperature of the slurry was 44-47° C. The white slurry was poured into a glass frit. The mixture was filtered, washed with DI water several times (total filtrate was ˜500 mL). Then 200 of 3 wt % sodium bicarbonate solution was added to the frit without vacuum and the pulp/sodium bicarbonate solution was allowed to sit for 10 minutes. Vacuum was applied to the frit and the pulp was then washed several times with water (total filtrate was 400-450 mL). Nomex® fibrid solution (0.43 wt % polymer) was added to the blender under maximum speed and the moist POD1 fiber mat from the frit was added to the blender. The mixture was blended at the maximum speed for 2 minutes. Then 150 mL of cold water was added and the blending was continued for 2 more minutes. The white slurry was quickly poured onto a paper filter in a glass frit and washed three times with water.

After the water had been filtered from the fiber mat, the mat was dried and calendered as described in Example 7.

TABLE 3
Weights of POD1 and Nomex ® fibrid used in making paper pulp

| | POD1 | POD1 | Nomex ® | Nomex ® |
|---|---|---|---|---|
| Reaction# | solution (g) | fiber (g) | solution (g) | fibrid (g) |
| A | 24.0 | 0.890 | 210.1 | 0.903 |
| B | 24.0 | 0.890 | 210.1 | 0.903 |
| C | 24.2 | 0.898 | 210.1 | 0.903 |

### Example 9

### Preparation of paper from poly(para-phenylene-1,3,4-oxadiazole)-co-poly(meta-phenylene-1,3,4-oxadiazole and Nomex® fibrids: Method 6

To a Waring blender containing 150 mL of 71.5° C. water was very slowly added POD1 solution (see Table 4 for actual weight) prepared in Example 1 (3.71 wt % polymer in sulfuric acid) as a thin stream while blending at maximum speed. The addition of the POD1 solution was accomplished by pouring slowly from a 25 mL scintillation vial fixed at ˜30 cm above the surface of the liquid in the blender over a 3.5 minute period. After the addition of the polymer mixture the blender was continued at maximum speed an additional 0.5 minutes. The resulting white slurry was poured into a glass frit and the formed POD1 fiber mat was washed with DI water several times. Then 300 of 3 wt % sodium bicarbonate solution was added to the rinsed blender and while blending at a speed that formed a fast but uniform vortex (low setting on variable speed blender) the POD1 fiber mat was added. Then the blending speed was increased to the maximum rate and continued for 3 minutes. The resulting slurry was filtered in a glass frit and washed with water repeatedly. Then 208 g of Nomex® fibrid solution (0.43 wt % polymer) was added to the blender under maximum speed and the moist POD1 fiber mat from the frit was added to the blender. The mixture was blended at the maximum speed for 2 minutes. The white slurry was quickly poured onto a paper filter in a glass frit and washed with water. The ratio of POD1:Nomex® in the prepared paper was 50:50?.

After the water had been filtered from the fiber mat, the mat dried and calendered as described in Example 7.

TABLE 4
Weights of POD1 and Nomex © fibrid
used in making the paper pulp

| | POD1 | POD1 | Nomex ® | Nomex ® |
|---|---|---|---|---|
| Reaction# | solution (g) | fiber (g) | solution (g) | fibrid (g) |
| Example 9 | 24.1 | 0.894 | 208.0 | 0.894 |

### Example 10

### Preparation of paper from poly(para-phenylene-1,3,4-oxadiazole) and Nomex® fibrids at 50:50 ratio

To a Waring blender containing 150 mL of 71.5° C. water was very slowly added POD2 solution (see Table 5 for actual weights) prepared in Example 2 (3.3 wt % polymer in sulfuric acid) as a thin stream while blending at maximum speed. The addition of the POD2 solution was accomplished by pouring slowly from a 25 mL scintillation vial fixed at ˜30 cm above the surface of the liquid in the blender over a 5.5 minute period. After the addition of the POD2 solution the blender was continued at maximum speed an additional 0.5 minutes. The resulting white slurry was poured into a glass frit. The mixture was filtered producing a fiber mat, which was washed with DI water several times. Then 250 mL of 3 wt % sodium bicarbonate solution was added to the rinsed blender and while blending at a speed that formed a fast but uniform vortex (low setting on variable speed blender) the POD2 fiber mat was added. Then the blending speed was increased to the maximum rate and continued for 4 minutes. The resulting slurry was filtered in a glass frit producing a fiber mat, which was washed with water repeatedly until a pH strip indicated the filtered water was neutral. Nomex® fribrid solution (0.45 wt % polymer) was added to the blender under maximum speed and the moist POD2 fiber mat from the fit was added to the blender. The mixture was blended at the maximum speed for 4 minutes. The resulting white slurry was quickly poured onto a paper filter in a glass frit and washed with water. The weight of the POD and Nomex for the paper pulp is Table X. The ratio of POD2:Nomex® in the prepared paper was 50:50.

TABLE 5
Weights of POD2 and Nomex ® fibrid used in making paper pulp

| | POD2 | POD2 | Nomex ® | Nomex ® |
|---|---|---|---|---|
| Reaction# | solution (g) | fiber (g) | solution (g) | fibrid (g) |
| Example 10 | 25.789 | 0.8510 | 189.119 | 0.8510 |

After the water had been filtered from the fiber mat, the mat was dried and calendered as described in Example 7.

The finished handsheet was cut into three strips for testing, each one inch (2.54 cm) wide by 5 inches (12.7 cm) long, using a razor. Test results reported in Table X were performed using a one inch (2.54 cm) wide by two inch (5.08 cm) long test area on an Instron® tensile tset machine (Instron; Norwood, Mass.) fitted with a 50 lb (22.68 kg) load cell. Each sample was clamped with 1″×½″ (2.54 cm×1.27 cm) rubber coated flat-face grips. Cross-head speed was set to 2 inches (5.08 cm)/minute. The results below are averages of the three sample strips.

TABLE 6
Tensile strength for POD2:Nomex ® 50:50 paper

| | |
|---|---|
| Absolute Tenacity (N/cm) | 36.92 |
| Tenacity at Max (MPa) | 33.06 |
| Elongation at Max (%) | 6.53 |

### Example 11

### Additional preparation of paper from poly(para-phenylene-1,3,4-oxadiazole) and Nomex® fibrids at 50:50 ratio

The following process was repeated six times as reactions A through F. To a Waring blender containing 150 mL of 71.5° C. water was very slowly added POD2 solution prepared in Example 2 (3.3 wt % polymer in sulfuric acid) (see Table 7 for actual weights) as a thin stream while blending at maximum speed. The addition of the POD2 solution was accomplished by pouring slowly from a 25 mL scintillation vial fixed at ˜30 cm above the surface of the liquid in the blender over a 5.5-8 minute period. After the addition of the polymer mixture the blender was continued at maximum speed an additional 0.5 minutes. The resulting white slurry was poured into a glass frit. The mixture was filtered and the resulting POD2 fiber mat was washed with DI water several times. Then 275 mL of 3 wt % sodium bicarbonate solution was added to the rinsed blender and while blending at a speed that formed a fast but uniform vortex (low setting on variable speed blender) the POD2 fiber mat was added. Then the blending speed was increased to the maximum rate and continued for 4 minutes. The resulting slurry was filtered and washed with water repeatedly until a pH strip indicated the filtered water was neutral. Nomex® fibrid solution (0.45 wt % polymer) (amounts in Table X) was added to the blender under maximum speed and the moist POD2 fiber mat from the frit was added to the blender. The mixture was blended at the maximum speed for 4 minutes. The resulting white slurry was quickly poured onto a paper filter in a glass frit and washed with water. After the water had been filtered from the fiber mat, the mat was dried and calendered as described in Example 7.

TABLE 7
Weights of POD2 and Nomex ® fibrid
used in making the paper pulp.

| | POD2 | POD2 | Nomex ® | Nomex ® |
|---|---|---|---|---|
| Reaction# | solution (g) | fiber (g) | solution (g) | fibrid (g) |
| A | 20.397 | 0.7192 | 159.82 | 0.7192 |
| B | 20.901 | 0.6897 | 153.274 | 0.6897 |
| C | 21.595 | 0.7126 | 158.363 | 0.7126 |
| D | 21.482 | 0.7089 | 157.535 | 0.7089 |
| E | 21.096 | 0.6962 | 154.704 | 0.6962 |
| F | 26.259 | 0.8665 | 192.566 | 0.8665 |

### Example 12

### Preparation of paper from poly(para-phenylene-1,3,4-oxadiazole) and Nomex® fibrids at 5:95 ratio or 95:5 ratio

The following process was repeated two times as reactions A and B. To a Waring blender containing 150 mL of 71.5° C. water was very slowly added POD2 solution prepared in Example 2 (3.3 wt % polymer in sulfuric acid) (see Table 8 for actual weights) as a thin stream while blending at maximum speed. The addition of the POD2 solution was accomplished by pouring slowly from a 25 mL scintillation vial fixed at ˜30 cm above the surface of the solution in the blender over a 2.5 minute period. After the addition of the polymer mixture the blender was continued at maximum speed an additional 0.5 minutes. The resulting white slurry was poured into a glass frit. The mixture was filtered producing a fiber mat, which was washed with DI water several times. Then 100 mL of 3 wt % sodium bicarbonate solution was added to the rinsed blender and while blending at a speed that formed a fast but uniform vortex (low setting on variable speed blender) the POD2 fiber mat was added. Then the blending speed was increased to the maximum rate and continued for 4 minutes. The resulting POD2 slurry was filtered in a glass frit? Producing a fiber mat which was washed with water repeatedly until a pH strip indicated the filtered water was neutral. Nomex® fibrid solution (0.47 wt % polymer) (amounts in Table 8) was added to the blender under maximum speed and the moist POD2 fiber mat from the frit was added to the blender. The mixture was blended at the maximum speed for 4 minutes. The resulting white slurry was quickly poured onto a paper filter in a glass frit and washed with water. After the water had been filtered from the fiber mat, the mat was dried and calendered as described in Example 7. The ratio of POD2:Nomex® in the prepared paper was 5:95.

Reaction C was prepared in the same manner as described for Reactions A and B using the amounts of solutions given in Table 8, except that the POD2 solution was added over an 8.5 minute period, 400 mL of 3 wt % sodium bicarbonate solution was added to the rinsed blender, and an additional 300 g of DI water was added with the Nomex® fibrid solution, The ratio of POD2:Nomex® in the prepared paper was 95:5.

TABLE 8
Weights of POD2 and Nomex ® fibrid
used in making the paper pulp

| | POD | POD | Nomex ® | Nomex ® |
|---|---|---|---|---|
| Reaction# | solution (g) | fiber (g) | solution (g) | fibrid (g) |
| A | 2.045 | 0.06749 | 274.372 | 1.2900 |
| B | 2.058 | 0.06791 | 276.154 | 1.2980 |
| C | 49.850 | 1.6451 | 18.018 | 0.08468 |

The finished handsheet from the 13A reaction was cut into three strips for testing, each one inch (2.54 cm) wide by 5 inches (12.7 cm) long, using a razor. Test results reported in Table 9 were performed as described in Example 11. The results below are averages of the three sample strips.

TABLE 9
Tensile strength of POD2:Nomex ® 5:95 paper

| | |
|---|---|
| Absolute Tenacity (N/cm) | 52.82 |
| Tenacity at Max (MPa) | 62.979 |
| Elongation at Max (%) | 4.35 |

The finished handsheet from the 130 reaction was tested as above except that the sheet was cut into four strips and the results in Table 10 are the averages from the four strips.

TABLE 10
Tensile strength of POD2:Nomex ® 95:5 paper

| | |
|---|---|
| Absolute Tenacity (N/cm) | 3.75 |
| Tenacity at Max (MPa) | 3.382 |
| Elongation at Max (%) | 1.65 |

### Example 13

### Preparation of paper from poly(para-phenylene-1,3,4-oxadiazole) and Kaolin clay at 50:50 ratio

To a Waring blender containing 150 mL of 71.5° C. water was very slowly added POD2 solution (see Table 11 for weight) prepared in Example 2 (3.3 wt % polymer in sulfuric acid) as a thin stream while blending at maximum speed. The addition of the POD polymer was accomplished by pouring slowly from a 25 mL scintillation vial fixed at ˜30 cm above the surface of the solution in the blender over a 5.5 minute period. After the addition of the POD2 solution the blender was continued at maximum speed an additional 0.5 minutes. The resulting white slurry was poured into a glass frit and filtered producing a fiber mat which was washed with DI water several times. Then 250 mL of 3 wt % sodium bicarbonate solution was added to the rinsed blender and while blending at a speed that formed a fast but uniform vortex (low setting on variable speed blender) the POD2 fiber mat was added. Then the blending speed was increased to the maximum rate and continued for 4 minutes. The resulting slurry was filtered producing a fiber mat which was washed with water repeatedly. 14.1758 g of Kaolin clay suspension in water (6.18 wt % clay) was weighed out, diluted with water to 189 g and added to the blender under high-speed followed by addition of the moist POD2 fiber mat from the frit. The mixture was blended under high speed for 4 minutes. 6.824 g of the flocculant solution Praestol™ (0.25 wt %) was slowly added and the mixture was stirred on low for 10 minutes. The resulting white slurry was quickly poured onto a paper filter in a glass frit and washed with water. The weights of the POD and Kaolin for the paper pulps are in the table below.

TABLE 11
Weights of POD2, Koalin clay, and Praestol ™ used in making the
paper pulp

| | POD2 | POD2 | Kaolin | | Praestol ™ | |
|---|---|---|---|---|---|---|
| Reac- | solution | fiber | solution | Kaolin | solution | Praestol ™ |
| tion# | (g) | (g) | (g) | clay (g) | (g) | (g) |
| 1 | 25.847 | 0.853 | 14.176 | 0.853 | 6.824 | 0.017 |

After the water had been filtered from the fiber mat, the mat was dried and calendered as described in Example 7.

The finished handsheet was cut into four strips and tested as described in Example 13. The results given in Table 12 are averages from the four sample strips.

TABLE 12
Tensile strength of POD2:Kaolin clay 50:50 paper

| | |
|---|---|
| Absolute Tenacity (N/cm) | 2.64 |
| Tenacity at Max (MPa) | 3.057 |
| Elongation at Max (%) | 1.61 |

### Example 14

### Preparation of paper from poly(para-phenylene-1,3,4-oxadiazole), Kaolin clay, and Nomex® fibrid at 30:40:30 ratio

The following process was repeated two times as reactions A and B. To a Waring blender containing 150 mL of 71.5° C. water was very slowly added POD2 solution prepared in Example 2 (3.3 wt % polymer in sulfuric acid) (see Table 13 for actual weights) as a thin stream while blending at maximum speed. The addition of the POD2 solution was accomplished by pouring slowly from a 25 mL scintillation vial fixed at ˜30 cm above the surface of the solution in the blender over a 8.0 minute period. After the addition of the POD2 solution the blender was continued at maximum speed an additional 0.5 minutes. The resulting white slurry was poured into a glass frit. The mixture was filtered producing a fiber mat which was washed with DI water several times. Then 250 mL of 3 wt % sodium bicarbonate solution was added to the rinsed blender and while blending at a speed that formed a fast but uniform vortex (low setting on variable speed blender) the POD2 fiber mat was added. Then the blending speed was increased to the maximum rate and continued for 4 minutes. The resulting slurry was filtered in a glass frit producing a fiber mat which was washed with water repeatedly. Kaolin clay solution (6.18 wt % polymer) was weighed out (amounts in Table 13), diluted with water to 189 g with water? followed by weighing out Nomex® fibrid solution (0.43 wt %) (amounts in Table 13). Both were added to the blender under high-speed. The POD2 fiber mat from the frit was cut into pieces using scissors before being added to the Nomex®/Kaolin mixture, which was then blended under high speed for 4 minutes. Flocculant solution Praestol™ (0.25 wt %) (amounts in Table 13) was slowly added and the mixture was stirred on low for 10 minutes. The resulting white slurry was quickly poured onto a paper filter in a glass frit and washed with water. After the water had been filtered from the fiber mat, the mat was dried and calendered as described in Example 7.

TABLE 13
Weights of POD2, Kaolin clay, Praestol ™, and Nomex ® fibrid
used in making paper pulp.

| | POD | POD | Kaolin | Kaolin | Praestol ™ | | Nomex ® | Nomex ® |
|---|---|---|---|---|---|---|---|---|
| | solution | fiber | solution | clay | solution | Praestol ™ | Solution | Fibrid |
| Reaction# | (g) | (g) | (g) | (g) | (g) | (g) | (g) | (g) |
| A | 21.315 | 0.672 | 15.169 | 0.938 | 8.175 | 0.020 | 156.31 | 0.689 |
| B | 20.839 | 0.657 | 14.837 | 0.917 | 7.995 | 0.020 | 152.82 | 0.678 |

The finished handsheet from Reaction B was cut into three strips and tested as in Example 13. The results given in Table 14 are averages from the three sample strips.

TABLE 14
Instron Tensile Test Results for POD2, Kaolin clay, and
Nomex ® fibrid paper at 30:40:30 ratio

| | |
|---|---|
| Absolute Tenacity (N/cm) | 25.03 |
| Tenacity at Max (MPa) | 16.91 |
| Elongation at Max (%) | 7.72 |

### Example 15

### Performance of 50:50 poly(para-phenylene-1,3,4-oxadiazole):Nomex® paper in aging studies

Aging studies were performed as described in General Methods using paper prepared in Example 12. Strips were cut from the A-F samples and then randomized before being separated into glass or steel tube for the aging tests. Three strips were tested for each time sample and averaged in the results of aging in steel tubes at 180° C. given in Table 15. The control upgraded Kraft paper (Product 22HCC with 3 mil thickness) was purchased from Weidmann Electrical Technology Inc. (Framingham, Mass.).

TABLE 15
Aging results of POD2:Nemex ® 50:50 paper in steel tubes at
180° C.

| | | | | | | | | |
|---|---|---|---|---|---|---|---|---|
| | | Max | Abs. | Tenacity | Elongation | | Retained | |
| Days | Modulus | Load | Tenacity | @ max | @ max | Tough | Tenacity | Standard |
| Aged | (Mpa) | (N) | (N/cm) | (Mpa) | (%) | (Mpa) | (%) | Deviation |

Upgraded kraft paper

| | | | | | | | | |
|---|---|---|---|---|---|---|---|---|
| 0 | 1909.94 | 109.8 | 86.46 | 115.92 | 26.52 | 14.468 | 100 | 4.829 |
| 3 | 3418.14 | 83.4 | 32.84 | 44.639 | 3.42 | 1.118 | 37.983 | 0.743 |
| 7 | 3334.82 | 69.82 | 27.49 | 36.615 | 1.83 | 0.427 | 31.795 | 4.4459 |
| 14 | 3137.58 | 60.15 | 23.68 | 31.592 | 1.61 | 0.304 | 27.388 | 2.479 |
| 28 | 3018.85 | 53.05 | 20.88 | 28.323 | 1.36 | 0.219 | 24.150 | 6.949 |

POD2 and Nomex ® fibrids at 50:50 ratio

| | | | | | | | | |
|---|---|---|---|---|---|---|---|---|
| 0 | 1464.57 | 39.78 | 31.32 | 29.334 | 4.65 | 0.97 | 100 | 24.061 |
| 3 | 1689.38 | 41.37 | 32.57 | 35.139 | 3.83 | 0.984 | 103.991 | 27.725 |
| 7 | 1666.02 | 50.14 | 39.48 | 38.836 | 4.56 | 1.132 | 126.054 | 11.444 |
| 14 | 1509.76 | 55.85 | 43.97 | 39.459 | 5.09 | 1.306 | 140.39 | 22.343 |
| 28 | 1764.72 | 46.11 | 36.31 | 38.191 | 5.53 | 1.43 | 115.932 | 5.078 |

The averaged results of aging in glass tubes at 200° C. are given in Table 16.

TABLE 16
Aging results of POD2:Nomex ® 50:50 paper in glass tubes at
200° C.

| | | Max | Abs. | Tenacity | Elongation | | Retained |
|---|---|---|---|---|---|---|---|
| Days | Modulus | Load | Tenacity | @ max | @ max | Tough | Tenacity |
| Aged | (Mpa) | (N) | (N/cm) | (Mpa) | (%) | (Mpa) | (%) |
| 0 | 1509.22 | 39.9 | 31.39 | 33.341 | 7.9 | 1.996 | 100 |
| 7 | 1583.43 | 52.2 | 41.12 | 41.441 | 5.49 | 1.485 | 124.294 |
| 9 | 1623.45 | 46.5 | 36.61 | 38.214 | 5.29 | 1.346 | 114.616 |
| 14 | 1599.4 | 37.9 | 29.83 | 30.238 | 3.49 | 0.695 | 90.693 |
| 28 | 1529.23 | 33 | 26 | 28.082 | 3.72 | 0.713 | 84.227 |

What is claimed is:

1. An insulating material comprising a nonwoven web, the web comprising a polymer of poly(meta-phenylene-1,3,4-oxadiazole) and a co-polymer of para-phenylene-1,3,4-oxadiazole or meta-phenylene-1,3,4-oxadiazole, wherein the insulating material does not include: (1) polymer or copolymer derived from a diaminodiphenyl sulfone, or (2) aromatic polyesters and copolyesters obtained from aromatic bisphenols and aromatic dicarboxylic acids.

2. The insulating material of claim 1 further comprising polymetaphenylene isophthalamide.

3.-4. (canceled)

5. The insulating material of claim 1 wherein a weight ratio of para-phenylene-1,3,4-oxadiazole to meta-phenylene-1,3,4-oxadiazole is from about 99:1 to about 1:99.

6. The insulating material of claim 2 comprising at least about 30 weight percent of polymetaphenylene isophthalamide.

7. The insulating material of claim 6 wherein a tensile strength represented by the measurement of tenacity at maximum is at least about 80% retained after 28 days of immersion in oil at 180° C.

8. A multilayer structure comprising the insulating material of claim 1.

9. A honeycomb structure comprising the insulating material of claim 1.

10. A device comprising an electrical conductor and an insulating material of claim 1 wherein the insulating material is an electrically insulating material.

11. The device of claim 10 wherein the device is a transformer.

12. The device of claim 11 wherein the transformer is oil filled.

13. The device of claim 11 wherein the transformer has a capacity of at least 200 kVa.

14. The device of claim 13 wherein the transformer has a capacity of at least 400 kVA.

15. A process for making a nonwoven insulating paper comprising the steps:
a) providing a solid, slurry, or solution of a (co)polymer of phenylene-1,3,4-oxadiazole;
b) optionally pulping the (co)polymer of phenylene-1,3,4-oxadiazole prior to step (c);
c) blending the solid, slurry, or solution of step (a) with poly-metaphenylene isophthalamide fibrids to form a polymer mixture, and pulping the phenylene-1,3,4-oxadiazole if it was not pulped in step (b);
d) draining excess liquid from the polymer mixture to yield a wet paper composition; and
e) drying and pressing the wet paper composition to make a formed paper.

16. The process of claim 15 wherein the liquid is drained from the slurry using a screen or wire belt.

17. The process of claim 16 further comprising calendering the formed paper with heat and pressure.

18. The process of claim 16 wherein the ratio of weight percent of (co)polymer of phenylene-1,3,4-oxadiazole to weight percent of polymetaphenylene isophthalamide is between about 30:70 and 5:95.
